(19) United States
(12) Patent Application Publication
(10) Pub. No.: US 2025/0066157 A1
(43) Pub. Date: Feb. 27, 2025

(54) BRAKE DEVICE FOR AN ELEVATOR CAR, USE THEREOF IN AN ELEVATOR SYSTEM, AND METHOD

(71) Applicant: Inventio AG, Hergiswil (CH)

(72) Inventors: Romeo Lo Jacono, Gravesano (CH); Erich Butler, Ebikon (CH); Gilles Trottmann, Meierskappel (CH); Jan Lustenberger, Eschenbach LU (CH); Sushil Kale, Pune Maharashtra (IN)

(21) Appl. No.: 18/720,683

(22) PCT Filed: Dec. 16, 2022
(86) PCT No.: PCT/EP2022/086394

§ 371 Date: Jun. 17, 2024

(30) Foreign Application Priority Data
Dec. 23, 2021 (EP) 21217277.9

(51) Int. Cl. B66B 1/34; B66B 5/18

(52) U.S. Cl. CPC B66B 1/3484; B66B 5/18

(57) ABSTRACT

A braking apparatus for braking a movable elevator car of an elevator system and for measuring load changes produced in the elevator car has at least one, preferably two, brakes for braking the elevator car relative to a stationary component of the elevator system. The braking apparatus includes a brake holding arrangement for holding the brake(s) on the elevator car, a load measuring device having a force transmission element for measuring a force acting on the force transmission element, and a load measuring device holding arrangement for holding the load measuring device on the elevator car.

### FIELD

The present invention relates to a braking apparatus for an elevator installation, by means of which apparatus a displaceable elevator car can be braked and load changes caused in the elevator car can be measured. The invention also relates to an elevator installation equipped with such a braking apparatus. The invention also relates to a method for measuring a load acting on an elevator car and to a method for setting a force to be exerted on an elevator car by a drive device in response to a load change in the elevator car using the braking apparatus described herein.

### BACKGROUND

In an elevator installation, an elevator car is typically displaced within a vertical elevator shaft between different levels or floors in a building. The elevator car is displaced by means of a drive device that drives support means, such as ropes or belts, that hold the elevator car, for example. The elevator car is usually guided by guide rails when it is displaced. In order to bring the elevator car to a stop at a desired floor, its displacement movements are generally braked by appropriately controlling the drive device.

When people enter or leave the elevator car when it stops at a floor, a resulting load change can lead to an elastic change in the length of the support means holding the elevator car. The position of the elevator car relative to the floor can thus easily change during the stop at the floor. In order to prevent a step being created between a floor of the elevator car and a standing surface at the floor, a change in position of the elevator car has conventionally been compensated for by means of so-called re-leveling, in which the drive device displaces the support means holding the elevator car in a targeted manner in such a way that the change in position of the elevator car is counteracted. However, carrying out such a re-leveling requires complex measures.

Alternatively, it has been proposed to provide a brake directly on the elevator car, with the aid of which the elevator car can be held in a fixed position during a stop at a floor. However, the problem can arise here that a load change in the car during the stop leads to an abrupt change in position of the car when the brake is subsequently released due to the changed car load.

Approaches for measuring the load acting on an elevator car have been described. For example, EP 1 278 694 B1 describes load handling means for traction elevators having an integrated load measuring device. An alternative load measuring device for an elevator car is described in EP 0 151 949 A2. A brake load measuring system in which load measuring cells interact with a brake is described in U.S. Pat. No. 6,483,047 B1. WO2021/084012 discloses a braking apparatus for an elevator car with integrated load measurement, and the use thereof in an elevator system.

### SUMMARY

There may be a need for, inter alia, a braking apparatus by means of which an elevator car of an elevator installation can be braked in an advantageous manner and which is also designed to be able to measure a load change caused in the elevator car. Furthermore, there may be a need for an elevator installation equipped with such a braking apparatus. There may be also a need for an advantageous method for measuring a load acting on an elevator car. Finally, there may be a need for an advantageous method for setting a force exerted on an elevator car by a drive device in response to a load change in the elevator car.

Such a need can be met by the subject matter of at least one of the advantageous embodiments defined in the following description.

According to a first aspect of the invention, a braking apparatus for braking a displaceable elevator car of an elevator installation and for measuring load changes caused in the elevator car is proposed. The braking apparatus has a brake for braking the elevator car relative to a stationary component of the elevator installation, a brake holding arrangement for holding the brake on the elevator car, a load measuring device having a force transmission element for measuring a force acting on the force transmission element, and a load measuring device holding arrangement for holding the load measuring device on the elevator car. The brake and the brake holding arrangement are designed such that the brake can be held on the elevator car by means of the brake holding arrangement in such a way that the brake can be displaced relative to the elevator car in a force direction generated by the brake. The load measuring device and the load measuring device holding arrangement are configured such that the load measuring device is to be held on the elevator car by means of the load measuring device holding arrangement such that the load measuring device is fixed relative to the elevator car in the force direction generated by the brake. The force transmission element of the load measuring device is operatively connected to the brake in order to be able to measure a force generated by the load measuring device as a result of the relative displacement of the brake on the load measuring device holding arrangement. The load measuring device holding arrangement and the load measuring device are designed and connected to the brake holding arrangement such that, when the brake is displaced in the force direction generated by the brake, a measuring force acting substantially perpendicular to the force direction generated by the brake is generated, which can be measured by the load measuring device.

According to a second aspect of the invention, an elevator installation which has an elevator car, a guide rail, and a braking apparatus according to an embodiment of the first aspect is described. The elevator car can be displaced along the guide rail. The braking apparatus is held on the elevator car by means of its brake holding arrangement and its load measuring device holding arrangement. The brake of the braking apparatus is configured to cooperate with the guide rail to brake the elevator car.

According to a third aspect of the invention, a method for measuring a load acting on an elevator car is described. The method comprises at least the following steps: (i) activating the brake of a braking apparatus according to an embodiment of the first aspect of the invention held on the elevator car while the elevator car is stationary, and (ii) measuring the load acting on the elevator car using the load measuring device of the braking apparatus.

Possible features and advantages of embodiments of the invention can be regarded, inter alia and without limiting the invention, as being based upon the concepts and findings described below.

To summarize briefly, a basic concept of the braking apparatus proposed here can be considered that of enabling two functionalities, namely braking the elevator car and measuring a load change caused in the elevator car, with a single device. For this purpose, the braking apparatus is constructed substantially in two parts.

A first part comprises the brake and the brake holding arrangement. The brake is designed to generate forces between the elevator car and a stationary component of the elevator installation, such as a guide rail, with the forces counteracting a movement of the elevator car or the weight thereof in order to brake the movement of the elevator car provided with the brake and/or to keep the elevator car stationary on the stationary component. The brake holding arrangement is designed to attach the brake to the elevator car.

A second part of the braking apparatus comprises the load measuring device and the load measuring device holding arrangement. The load measuring device is designed to measure loads or forces that act on a part of the load measuring device referred to hereinafter as the force transmission element. The load measuring device holding arrangement is configured to attach the load measuring device to the elevator car.

The two parts of the braking apparatus are not only designed for different functionalities, but are also attached to or held on the elevator car in different ways due to the different designs of their respective holding arrangements.

On the one hand, the brake and the brake holding arrangement are designed in such a way that the brake is not secured to the elevator car by means of the brake holding arrangement so as to be absolutely stationary, but can be displaced at least slightly relative to the elevator car, in particular in a direction of the force direction generated by the brake, i.e., typically a direction in which the elevator car moves during its journey or a direction opposite thereto. In other words, the brake holding arrangement, together with the brake fastened thereto, can move within a certain tolerance range or a certain play along the direction of movement of the car relative to the elevator car. The tolerance range can be, for example, a few tenths of a millimeter, in particular, for example, less than 1 mm.

On the other hand, the load measuring device and the load measuring device holding arrangement are designed in such a way that the load measuring device is fixedly secured to the elevator car by means of the load measuring device holding arrangement at least in the force direction generated by the brake, i.e., the load measuring device is attached to the elevator car as rigidly and free of play as possible.

Accordingly, the brake held on the elevator car with a certain degree of freedom of movement can move at least slightly relative to the load measuring device fixed rigidly on the elevator car.

The force transmission element of the load measuring device is operatively connected to the brake. If, for example, the elevator car, together with the load measuring device rigidly coupled thereto, moves relative to the brake, which, when activated, is held stationary on the stationary component of the elevator system, the relative movement of the brake relative to the load measuring device accordingly transmits (substantially proportionately) a force via the force transmission element to a suitable counter-element of the load measuring device. This force can be measured by the load measuring device.

Accordingly, the load measuring device can measure forces which act on the elevator car, in particular in its direction of movement, i.e., typically in the vertical direction. In particular, load changes in the elevator car can be determined using the load measuring device.

The load measuring device holding arrangement and the load measuring device are designed and connected to the brake holding arrangement such that, when the brake is displaced in the force direction generated by the brake relative to the elevator car, a force acting substantially perpendicular to the force direction generated by the brake is produced. The load measuring device holding arrangement and load measuring device are designed such that the force can be measured by the load measuring device.

In other words, the load measuring device holding arrangement and the load measuring device are designed such that a force (measuring force) acting perpendicular to the—displacement can be caused by the displacement of the brake and can be measured accordingly. The force is rotated, i.e., transformed, by substantially 90° in its direction of action by the load measuring device holding arrangement.

According to one embodiment, the load measuring device holding arrangement is elastically deformable such that, in the event of a relative displacement of the brake, the elastic deformation results in a measuring force that is substantially proportional to the braking force and load. The measuring force is, in particular, smaller than a braking force causing the relative displacement.

During the conversion already described above, which is caused by the holding arrangement, damping can also be caused by the load measuring device holding arrangement. This allows for the measuring force to be changed in terms of its amplitude and direction.

This has the advantage that the force caused by the displacement undergoes some kind of filtering during the conversion (damping+suppression of forces also acting in the direction of the displacement, but not via the brake). In particular, the signal/noise ratio in the force (measured variable) can be improved, i.e., increased. In particular, the effects of forces exerted on the car by the support means, for example, can be attenuated or damped before measurement at the load measuring device. Measurement can be simplified or improved.

According to one embodiment, the load measuring device holding arrangement is designed to be substantially trapezoidal and/or triangular.

In particular, the load measuring device holding arrangement can be designed as a substantially isosceles trapezoid. Preferably, the load measuring device holding arrangement is designed as a double trapezoid, wherein they can be designed such that the longer base side (referred to also as the base) of each of the two trapezoids come to lie on top of each other. In particular, these two longer base sides lying on top of each other are arranged parallel to the force direction that causes the brake to be displaced. Preferably, the trapezoidal parts are designed to be identical, in particular in the form of two identical isosceles trapezoids. It is also preferred for the two longer base sides of the trapezoids to not be formed. In other words, the load measuring device is designed as a kind of double trapezoid, i.e., polygon, wherein the polygon consists only of the shorter base sides and the legs of the two trapezoids, wherein the two longer base sides are not implemented. This has the advantage that the polygon can be deformed in the direction of the force generated by the brake.

Due to the elastic deformation of the load measuring device holding arrangement, a force exerted parallel to the longer base sides lying on top of each other and caused by the displacement of the brake results in some kind of shortening of the (imaginary) longer base sides of the two trapezoids and thus in an increase in the angles at which the legs of the trapezoid are positioned in relation to the longer base side of the trapezoids, which in turn results in an increase in the distance between the two shorter base sides.

In a substantially comparable embodiment of the load measurement holding arrangement, at least one, preferably both, trapezoid(s) is/are replaced by a substantially triangular part(s).

In one embodiment, the load measuring device with the force transmission element is arranged between the two shorter base sides of the trapezoids so that a change in the distance between the two shorter base sections can be measured by the load measuring device.

In one embodiment, the load measuring device with the force transmission element is arranged between two connecting pieces, with each of the connecting pieces being attached to one of the four legs of the two trapezoids. Elastic deformation of the trapezoids results in a displacement of the connecting pieces relative to each other, so that a load measuring device attached to the connecting pieces makes such a displacement measurable.

In one embodiment, the load measuring device is arranged in the load measuring device holding arrangement in such a way that the force transmission element extends substantially perpendicular to the force direction generated by the brake and can be displaced in this direction.

This makes it particularly easy to measure the force changed by the deformation in the direction of substantially 90°. Furthermore, the influence of forces acting in the force direction of the brake is reduced.

In one embodiment, the load measuring device holding arrangement comprises at least two fixing elements to hold the load measuring device holding arrangement on the elevator car. The fixing elements are arranged such that a line running through the two fixing elements is substantially perpendicular to the force direction generated by the brake.

The aim is to fix the load measuring device holding arrangement firmly on the car in the direction of the acting force, so that a displacement of the brake, which is not fixed to the car in this direction, results only in an elastic deformation of the load measuring device holding arrangement, but not in a displacement. Two fixing elements, in particular screws or bolts, which are mounted on a line running perpendicular to the force direction, make this particularly easy.

In other words, the brake holding arrangement in particular can be designed in such a way that the brake fastened thereto can be attached to the elevator car with a certain amount of play, so that the brake can move easily relative to the elevator car within a tolerance range due to the forces generated when the brake is activated.

This can be used, for example, to ensure that the brake can move slightly relative to the elevator car in the event of relatively low forces, for example up to the weight forces of the elevator car to be held.

In particular, according to one embodiment, the brake holding arrangement can have some kind of slots, the longitudinal direction of which extends parallel to the force direction generated by the brake and through which fixing elements held stationary on the elevator car can extend in order to hold the brake holding arrangement on the elevator car.

In other words, one or more (open or closed) slots can be provided in the brake holding arrangement, through which slots fixing elements, such as screws or bolts which are fixedly connected to the elevator car, can extend.

A slot can be an elongate through-opening which has larger dimensions in a direction parallel to the force direction generated by the brake, i.e., in a length direction, than in a direction transverse thereto, i.e., in a width direction. For example, the dimensions in the width direction can substantially correspond to those of the fixing element extending through the slot, so that there is a form fit in the width direction, whereas the dimensions in the length direction can be at least slightly larger than those of the fixing element, so that the fixing element can move within a tolerance range defined by the slot in the force direction.

Longitudinal ends of the slot may or may not be present. They act as a mechanical limitation for a relative movement of the brake in the longitudinal direction. This means that the longitudinal ends form a mechanical stop that determines the position up to which the brake and the elevator car can be moved relative to each other.

Accordingly, in the event of emergency braking, for example, the fixing elements of the elevator car that extend through the slots of the brake holding arrangement can move relative to the brake up to the longitudinal ends of the slots at most. Further displacement is avoided by the form fit which then occurs between the fixing elements and the ends of the slots. Accordingly, the large forces that occur in the event of emergency braking, for example, can be transmitted between the brake and the elevator car via the fixing elements and the brake holding arrangement.

According to one embodiment, the load measuring device holding arrangement is arranged, dimensioned, and configured in such a way that the load measuring device holding arrangement deforms substantially only elastically when a force which corresponds to a weight of the elevator car, including a maximum permissible payload of the elevator car, is transmitted between the brake holding arrangement and the load measuring device holding arrangement.

In other words, the load measuring device holding arrangement can be designed such, i.e., dimensioned and/or formed in terms of material and strength such, that it only undergoes elastic deformation under forces that typically occur during normal operation of the elevator system, for example when the elevator car is to be held at a floor.

To this end, several different influencing variables can be appropriately selected. For example, the spatial arrangement of the load measuring device holding arrangement, i.e., in particular its position, orientation, and/or extension direction, can affect its mechanical load-bearing capacity and/or its elastic deformability. In addition, the dimensioning of the load measuring device holding arrangement, i.e., in particular its cross section, width, length, height, etc., can affect the load-bearing capacity and/or elastic deformability of the connecting piece arrangement. Furthermore, other configuration parameters, such as a material used, processing carried out during production, etc., can influence the load-bearing capacity and/or elastic deformability of the load measuring device holding arrangement. All of these parameters can be suitably selected so that the load measuring device holding arrangement is configured, for example based on the properties of the elevator car (e.g., its weight and payload) and/or based on the requirements of the entire elevator system (e.g., safety requirements regarding braking processes), in normal operation of the elevator system, to react to forces acting thereon only with an elastic deformation, but without plastic deformation.

In particular, according to one embodiment, the load measuring device holding arrangement can be arranged, dimensioned, and configured in such a way that, when a force which corresponds to a weight of the elevator car including a maximum permissible payload of the elevator car is transmitted between the brake holding arrangement and the load measuring device holding arrangement, the connecting piece arrangement deforms by less than 1 mm, preferably less than 0.5 mm, and more preferably only between 0.05 mm and 0.3 mm, in the force direction generated by the brake.

In other words, the elevator car should be able to move slightly relative to the brake during a braking process. However, the extent of this relative movement should be limited by the specifically selected configuration of the load measuring device holding arrangement to such an extent that no relative movements of more than 0.5 mm, for example, occur under normal conditions. For many applications, it can even be advantageous if the connecting piece arrangement only allows relative movements of less than 0.2 mm under normal conditions.

According to one embodiment, the brake holding arrangement, the load measuring device holding arrangement are designed in one piece with a common part. For example, the brake holding arrangement and the load measuring device holding arrangement may be formed in one piece from a stamped sheet metal part.

In other words, a single part, such as a metal sheet stamped into a suitable shape, can form both the brake holding arrangement and the load measuring device holding arrangement.

The entire part can be easy to produce and can be adapted to the forces to be absorbed and transmitted, for example by a suitable choice of a sheet metal, in particular with regard to a thickness of the sheet metal and a material of the sheet metal.

The one-piece design of all regions of such a part makes it possible, for example, to avoid increased wear at weak points that would otherwise occur in a multi-piece part at transitions between segments of the multi-piece part. The one-piece part can also withstand repeated mechanical loads over the long term.

According to one embodiment, the force transmission element can be connected to a counter-element of the load measuring device, which counter-element is fixed to the load measuring device holding arrangement via a strain gage.

In other words, a strain gage can be used to measure the forces acting on the load measuring device via the force transmission element. Thus, using the strain gage, the forces acting between the brake holding arrangement and the load measuring device holding arrangement when the brake is activated, and thus ultimately the forces acting between the activated brake and the elevator car braked thereby, can be measured. Using a strain gage for this task enables a very robust design of the load measuring device. Furthermore, the strain gage makes it possible to measure the acting forces very precisely and reproducibly.

According to one embodiment, the force transmission element and the counter-element are each supported on a connecting piece which protrudes from one of the legs of the substantially trapezoidal load measuring device holding arrangement. This makes it particularly easy to attach the load measuring device to the load measuring device holding arrangement.

According to one embodiment, the load measuring device can be configured to generate an electrical signal that represents the force acting on the force transmission element.

For example, the load measuring device can have a sensor system that can monitor physical parameters that allow the forces acting on the force transmission element to be inferred. The sensor system can generate electrical signals on the basis of the monitored physical parameters. Such electrical signals can be forwarded in a simple manner and, for example, transferred to a controller of the elevator installation or an external monitoring device. Based on the signals, the forces acting on the elevator car can then be inferred. For example, the controller of the elevator installation can thus be informed of the payload currently in the elevator car, so that the controller can control the drive device according to the load.

According to one embodiment, the brake of the braking apparatus described can be configured as a holding brake to hold the elevator car stationary against its weight during a stop. In particular, it can be preferable to additionally configure the brake as a safety brake in order to brake the elevator car in an emergency in the event of a free fall.

In other words, the brake should at least be designed in such a way that it can be used to keep the elevator car stationary on the stationary component of the elevator installation that interacts with the brake, i.e., on a guide rail, for example, while the elevator car is stopped at a floor, for example. As such a holding brake, the brake can prevent the elevator car from moving due to load changes when passengers get on or off the elevator car.

In addition, it can be advantageous to design the brake to be even more loadable so that it can also act as a safety brake. In this case, the brake should be configured to be able to generate very large forces between the elevator car and the stationary component, for example in order to be able to brake the elevator car to a standstill over a short distance, even in the event that all of the support means holding the elevator break and the elevator car goes into free fall. In order to be able to reliably transmit the very high forces that occur temporarily during such a safety braking process from the brake to the elevator car, the load measuring device holding arrangement can be configured so as to be stable enough to not undergo too much of a plastic deformation under the large forces.

Therefore, using a braking apparatus according to an embodiment of the first aspect of the invention, the brake of an elevator car, on which the brake holding arrangement and the load measuring device holding arrangement of the braking apparatus are held, can reliably interact with the guide rail, for example, in order to be able to brake the elevator car in an elevator system according to an embodiment of the second aspect of the invention.

In addition, the braking apparatus can be used within the scope of a method according to an embodiment of the third aspect of the invention in order to be able to measure the current load acting on the elevator car. In particular, temporary load changes can be measured.

For example, the brake of the braking apparatus can be activated for this purpose while the elevator car is gradually stopped at a floor and is stationary. In this case, the brake can, for example, only be activated after the elevator car has been stopped at the floor by suitable control of the drive device. Alternatively, the brake can be used to actively brake a movement of the elevator car to a standstill, in which case the brake can then remain activated during the standstill.

The activated brake can prevent the elevator car from moving during a stop at a floor, for example when passengers are getting on or off. However, there is a load change in the elevator car as a result of the passengers getting on or off. When using the braking apparatus described herein, the load measuring device thereof can be used to determine such load changes. This can be used, among other things, to make it possible to detect overcrowding of the elevator car and thus an overload.

Alternatively or additionally, according to an embodiment of the fourth aspect of the invention, a load change in the car can be measured using the method described and the information thus obtained can be used to set the force exerted by the drive device on the elevator car in such a way that the measured load change is compensated for.

In other words, the load measuring device can first be used to measure how much heavier or lighter the elevator car becomes as a result of passengers getting on or off. Without appropriate countermeasures, the load change would result in the elevator car abruptly dropping downward or sliding upward when the holding brake is subsequently released, since the elastic support means holding the elevator car would lengthen or shorten as a result of the load change. By measuring the load change in the elevator car with the load measuring device, the drive device can be accordingly controlled in order to be able to suitably set the force acting on the support means even before the holding brake is released, so that when the holding brake is released, the elevator car does not drop down or slide up. The process described can also be referred to as an adjustment to be carried out in advance of the torque to be generated by the drive device (pre-torquing).

According to one embodiment, the method described can be carried out in a particularly simple manner if, before the load change occurs, a force measured by the load measuring device is measured as a reference force. After the brake has been activated and the load in the elevator car has changed, the force exerted on the elevator car can then be set in such a way that the load measuring device measures a force corresponding to the reference force.

In other words, before the brake of the braking apparatus is activated and also before an elevator door is opened and passengers can thus get on and off, for example, a current value of the force measured by the load measuring device can be determined and stored as a reference value. If there is then a load change within the elevator car due to a changed number of passengers, this can be recognized by the load measuring device.

However, it is not necessary to carry out an absolute measurement of the forces generated by the load changes and determine the control signals to be sent to the drive device in order to be able to set the resulting torque in such a way that these load changes are compensated for. Instead, the drive device can simply be controlled so as to successively change its torque. At the same time, the way in which the current force measured by the load measuring device changes can be monitored. If this force corresponds to the initially determined reference value, this means that the torque generated by the drive device is set appropriately in order to be able to compensate for the load change that has taken place in the meantime, and therefore the brake can be released without an abrupt change in position of the elevator car.

Furthermore, the device, as well as the methods as described above and below, can be used to ensure that there is no maintenance technician in the car. For example, before switching from normal operation to maintenance operation, the car weight can be measured, and this value can then be compared with a value measured after the maintenance work before switching back to normal operation. If there is a deviation, switching back to normal operation can be prevented. This is particularly advantageous in elevator installations which have no headroom, since it is important under all circumstances to avoid the elevator installation being in normal operation when people are in the shaft. In contrast to a conventional load measurement in the car floor, in which a person is only detected if their weight is on the car floor, but not if the person is standing on the car roof, load measurement at the brake of the car, as described above and below, allows such an application.

It should be noted that some of the possible features and advantages of the invention are described herein with reference to different embodiments of the braking apparatus itself and of the elevator installation equipped with the apparatus, as well a use of this braking apparatus for measuring the load acting on the elevator car or for setting a force to be exerted by the drive device on the elevator car in response to load changes. A person skilled in the art will recognize that the features can be suitably combined, adapted, or exchanged in order to arrive at further embodiments of the invention.

Embodiments of the invention will be described below with reference to the accompanying drawings, wherein neither the drawings nor the description are intended to be interpreted as limiting the invention.

### DESCRIPTION OF THE DRAWINGS

FIG. 1 schematically shows an elevator installation according to an embodiment of the present invention.

FIG. 2 schematically shows an elevator installation according to an embodiment of the present invention.

FIG. 3 is a front view of a braking apparatus according to an embodiment of the present invention and FIG. 3A is enlarged portion of the rear of the braking apparatus shown in FIG. 3.

The drawings are merely schematic, and not to scale. Like reference signs denote like or equivalent features in the various drawings

### DETAILED DESCRIPTION

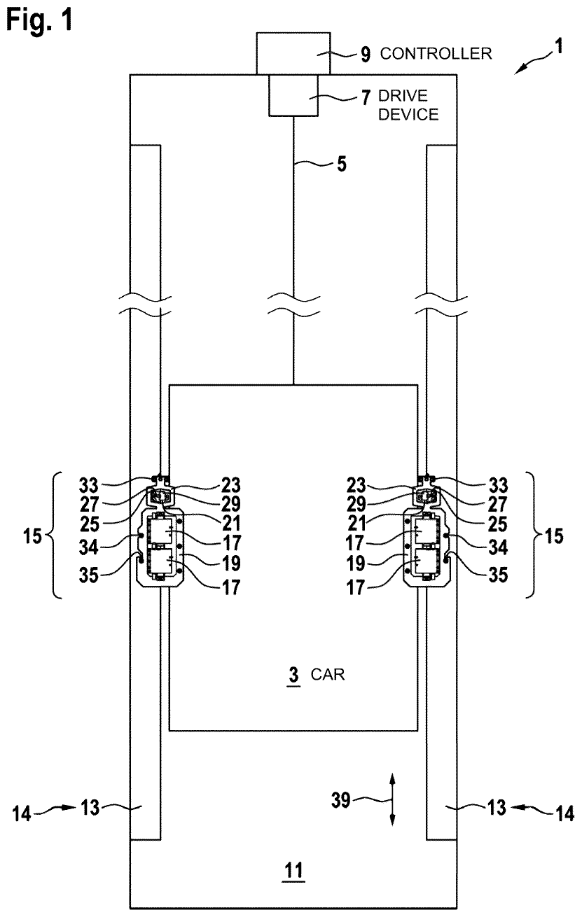

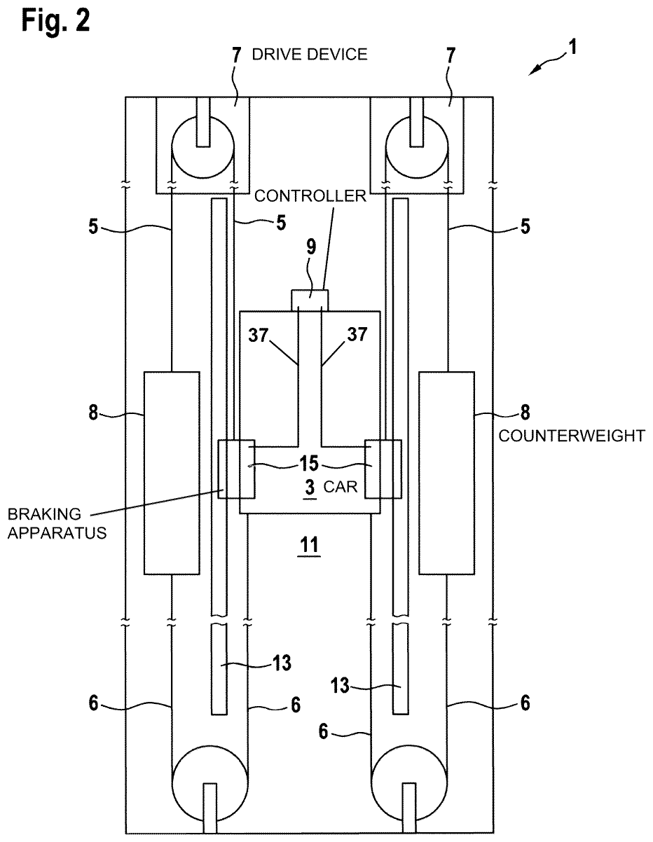

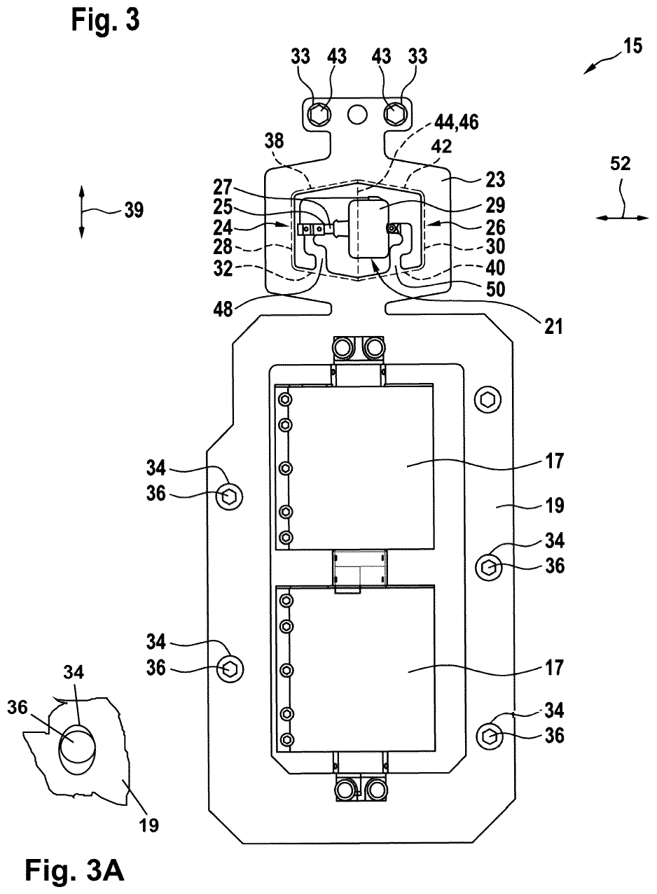

FIGS. 1 and 2 show differently designed elevator systems 1 having a braking apparatus 15 according to two embodiments of the present invention. In FIG. 3, a specific embodiment of the braking apparatus 15 is shown larger and with more detail.

The elevator installation 1 shown in FIG. 1 comprises an elevator car 3 which can be held by cable-like or belt-like support means 5, for example, and displaced in an elevator shaft 11. The support means 5 can be displaced by a drive device 7 for this purpose. The drive device 7 is controlled by a controller 9. During its displacement, the elevator car 3 is guided on both sides on at least one guide rail 13 acting as a stationary component 14.

In particular, in order to be able to keep the elevator car 3 stationary during a stop at a desired position, such as at a floor, the elevator car 3, after it has been moved to the desired position by means of the drive device 7, can be temporarily fixed with the aid of brakes 17 provided on its braking apparatuses 15 to the stationary guide rails 13. Each of the brakes 17 is fastened to a frame of the elevator car 3, for example, with the aid of brake holding arrangements 19.

At least one of the braking apparatuses 15 also has a load measuring device 21. The load measuring device 21 has a force transmission element 25 and a counter-element 29. Between the force transmission element 25 and the counter-element 29, the load measuring device 21 can have a sensor, for example in the form of a strain gage 27, with the aid of which a force acting on the load measuring device 21 between the force transmission element 25 thereof and the counter-element 29 thereof can be measured. The load measuring device 21 can, for example, have evaluation electronics in its counter-element 29, by means of which electronics the measurement parameters prevailing at the sensor can be converted into electrical signals. The load measuring device 21 is also fastened to the elevator car 3 via a load measuring device holding arrangement 23.

FIG. 2 shows a further embodiment of an elevator system 1 according to the invention. In this case, the braking apparatus 15 is shown only schematically and can be configured to be similar in detail to the embodiment shown in FIG. 1. The elevator installation 1 has an elevator car 3 and two counterweights 8. The elevator system 1 comprises two drive devices 7, the drive devices being arranged in the shaft head of the elevator shaft 11. In this embodiment, the elevator installation 1 further comprises two support means 6 below the elevator car 3. These support means 6 each lead from a lower end of the elevator car 3, over a deflection roller on the shaft pit floor, to a lower part of the respective counterweight 8.

A braking apparatus 15 as described above and below proves to be particularly advantageous when used in such an elevator system 1, since braking on the drive devices 7, i.e., via traction support means 6, can be avoided.

It also proves to be advantageous in such an elevator installation 1 to integrate the load measurement in the braking apparatus 15 provided on the elevator car 3 and not to carry it out in the support means fastenings, as is usually the case.

FIG. 3 shows the braking apparatus 15 in detail. The brake holding arrangement 19 is formed with slot-like recesses 34 (covered by washers of the fixing elements 36). A longitudinal direction of the recesses 34 is substantially parallel to a force direction 39 in which a force generated by the brake 17 is directed. The force direction 39 substantially corresponds to the direction of movement of the elevator car 3 and is therefore substantially vertical. The length of the recesses 34 can, for example, be about 0.5 mm greater than their width. A fixing element 36 (with a washer), for example in the form of a bolt or a screw, extends through each of the slot-like recesses 34 and can be fixed to the elevator car 3 or to the frame thereof. The brake holding arrangement 19 can thus be held on the elevator car 3 via the fixing elements 36, but can be moved slightly, and initially only, vertically relative to the elevator car 3 by displacing the fixing element 36 within the slot-like recess 34. One of the recesses 34 and the associated fixing element 36 are shown in FIG. 3A from a rear of the braking apparatus 15.

The load measuring device holding arrangement 23 has a plurality of round holes 33. Fixing elements 43 can in turn extend through the round holes 33, via which elements the load measuring device holding arrangement 23 can be fastened to the elevator car 3 or to the frame thereof substantially without play. In the exemplary embodiment shown, the round holes 33 are arranged on a line (not shown) which extends substantially perpendicular to the force direction 39.

Accordingly, the brake 17 held by the brake holding arrangement 19 can be displaced slightly in the force direction 39 relative to the load measuring device holding arrangement 23 or relative to the elevator car 3 when a force in the force direction 39 is generated by activating the brake 17.

Such a relative displacement causes a deformation of the load measuring device holding arrangement 23. The load measuring device holding arrangement 23 is arranged, dimensioned, and configured in such a way that this deformation is usually elastic, at least as long as the brake 17 only generates the forces required to hold the elevator car 3 and the payload thereof, for example when stopping at a floor.

The load measuring device holding arrangement 23 is designed as a substantially double, isosceles trapezoid (first trapezoid 24 and second trapezoid 26, see auxiliary lines). The trapezoids 24, 26 are each formed only of the shorter base sides 28/30 and of the legs 32, 38 or 40, 42, wherein the two longer base sides 44, 46 are only fictitious. The longer base sides 44 or 46 (referred to also as the base) of the two trapezoids lie on top of each other. These two longer base sides 44, 46 lying on top of each other are arranged substantially parallel to the force direction 39 in which the brake 17 can be displaced. The two trapezoids 24, 26 are designed as identical isosceles trapezoids.

The load measuring device 21 with the force transmission element 25 is arranged between two connecting pieces 48, 50. The first connecting piece 48 is connected to, or formed on, the leg 32 of the first trapezoid 24, which is located closer to the brake 17. The second connecting piece 50 is connected to, or formed on, the leg 40 of the second trapezoid 26, which is located closer to the brake 17. Elastic deformation of the trapezoids 24, 26 results in a displacement of the connecting pieces 48, 50 relative to each other, so that a load measuring device 21 attached to the connecting pieces 48, 50 makes such a displacement measurable. Displacement is substantially proportional to the force acting in the force direction 39 and caused by the displacement of the brake holding arrangement 19.

The load measuring device 21 and the force transmission element 25 are arranged via the connecting pieces 48, 50 in the load measuring device holding arrangement 23 such that the force transmission element 25 extends substantially perpendicular to the force direction 39 generated by the brake 17 and can be displaced in this direction (indicated by arrow 52).

However, the relative displacements between the brake 17 and the car 3 caused when the brake 17 is activated can also be used to make it possible to use the load measuring device 21 to measure loads or load changes currently acting on the elevator car 3.

For this purpose, in the example shown, the counter-element 29 of the load measuring device 21 is fixedly connected, for example screwed, to the load measuring device holding arrangement 23. The force transmission element 25 is coupled, for example, to a part of the brake holding arrangement 19 and is thus operatively connected to the brake 17. Electronics (not shown) provided in counter-element 29, for example, can be used e.g., to measure mechanical stresses that occur in the strain gage 27 arranged between the force transmission element 25 and the counter-element 29 due to the forces generated by the relative displacement. The electronics can then produce an electrical signal which can act as a measure of the force to which the load measuring device 21 is subjected.

It is therefore possible not only to use the brake 17 of the braking apparatus 15 to brake the elevator car 3, but also to use the load measuring device 21 of the braking apparatus to measure a load acting on the elevator car 3.

During operation of the elevator installation 1, the elevator car 3 can be transported to a floor by means of the drive device 7, for example. In order to prevent the elevator car 3 from subsequently moving up or down when passengers get on and off due to the resulting load changes, the brake 17 of the braking apparatus 15 can be activated, for example via a control line 37 (see FIG. 2), before the car doors are opened.

A force currently acting between the brake 17 and the elevator car 3 can be measured using the load measuring device 21 in advance or at least before a load change can occur in the elevator car 3, i.e., before the car door is opened, for example. This force can usually be zero, for example, particularly if the elevator car 3 was braked to a standstill exclusively by controlling the drive device 7 and the brake 17 was only activated afterwards. However, if the brake 17 was also used to decelerate the movement of the elevator car 3, this force can also have a value other than zero. This previously measured force can be stored as a reference value.

As soon as load changes occur when passengers subsequently get in and out of the car, they can be measured using the load measuring device 21. The information about the measured load changes can be used to vary the forces exerted on the elevator car 3 via the support means 5 by controlling the drive device 7 in a targeted manner in such a way that the load changes which have occurred in the meantime are compensated for.

Alternatively, the drive device 7 can change the forces acting on the elevator car 3 via the support means 5 until the force currently measured by the load measuring device 21 matches the previously determined reference value again.

It can be ensured in both cases that changed load conditions within the elevator car 3 are compensated for by suitably tensioning or relaxing the support means 5 using the drive device 7 in such a way that the entire elevator car 3, including the payload thereof, which has changed in the meantime, is held by the support means 5 again. In this state, the brake 17 can be released without the elevator car 3 then moving abruptly.

Finally, it should be noted that terms such as “comprising,” “having,” etc., do not exclude other elements or steps, and terms such as “a” or “an” do not exclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A braking apparatus for braking a displaceable elevator car of an elevator system and for measuring load changes caused in the elevator car, the braking apparatus comprising:
a brake adapted to brake the elevator car relative to a stationary component of the elevator system;
a brake holding arrangement adapted to hold the brake on the elevator car;
a load measuring device with a force transmission element, the load measuring device adapted to measure a force acting on the force transmission element;
a load measuring device holding arrangement adapted to hold the load measuring device on the elevator car;
wherein when the brake is held on the elevator car by the brake holding arrangement the brake is displaceable relative to the elevator car in a force direction of a force generated by the brake when the brake holds the elevator car on the stationary component;
wherein when the load measuring device is held on the elevator car by the load measuring device holding arrangement the load measuring device is fixed relative to the elevator car in the force direction;
wherein the force transmission element is operatively connected to the brake such that the load measuring device measures a force acting between the brake and the load measuring device due to a displacement of the brake relative to the load measuring device; and
wherein the load measuring device holding arrangement is connected to the brake holding arrangement such that the force measured by the load measuring device acts perpendicular to the force direction.

17. The braking apparatus according to claim 16 wherein the load measuring device holding arrangement is elastically deformable such that the displacement of the brake generates the force measured by the load measuring device as proportional to the force generated by the brake.

18. The braking apparatus according to claim 17 wherein the force measured by the load measuring device is smaller than the force generated by the bake.

19. The braking apparatus according to claim 16 wherein the load measuring device holding arrangement has a trapezoidal and/or triangular shape.

20. The braking apparatus according to claim 16 wherein the load measuring device is arranged in the load measuring device holding arrangement such that the force transmission element extends in a measured force direction perpendicular to the force direction and the force transmission element is displaceable in the measured force direction.

21. The braking apparatus according to claim 16 wherein the load measuring device holding arrangement includes two fixing elements adapted to hold the load measuring device holding arrangement on the elevator, the fixing elements being arranged on a line running perpendicular to the force direction when the load measuring device holding arrangement is held on the elevator car.

22. The braking apparatus according to claim 16 wherein the brake holding arrangement has a slot formed therein, a longitudinal direction of the slot extending parallel to the force direction when the brake holding arrangement is held on the elevator car, and a fixing element extending through the slot to hold the brake holding arrangement on the elevator car.

23. The braking apparatus according to claim 16 wherein the load measuring device holding arrangement is configured to deform only elastically when a force corresponding to a weight of the elevator car, including a maximum permissible payload of the elevator car, is transmitted between the brake holding arrangement and the load measuring device holding arrangement.

24. The braking apparatus according to claim 16 wherein the load measuring device holding arrangement is configured to deform by less than 1 mm in the force direction when a force corresponding to a weight of the elevator car, including a maximum permissible payload of the elevator car, is transmitted between the brake holding arrangement and the load measuring device holding arrangement.

25. The braking apparatus according to claim 16 wherein the brake holding arrangement and the load measuring device holding arrangement are formed in one piece by a common part.

26. The braking apparatus according to claim 25 wherein the common part is a stamped sheet metal part.

27. The braking apparatus according to claim 16 wherein the force transmission element is connected by a strain gage to a counter-element of the load measuring device and the counter-element is fixed to the load measuring device holding arrangement.

28. The braking apparatus according to claim 27 wherein the load measuring device holding arrangement has a trapezoidal shape with legs and the force transmission element and the counter-element are each supported on a separate connecting piece, the connecting pieces each protruding from one of the legs of the load measuring device holding arrangement.

29. The braking apparatus according to claim 16 wherein the brake is a holding brake adapted to hold the elevator car stationary against a weight of the elevator car during a stop at the stationary component.

30. The braking apparatus according to claim 29 wherein the brake also is a safety brake adapted to brake the elevator car in an emergency due to a free fall.

31. An elevator system comprising:
an elevator car;
a guide rail along which the elevator car is displaceable;
the braking apparatus according to claim 16;
wherein the braking apparatus is held on the elevator car by the brake holding arrangement and the load measuring device holding arrangement; and
wherein the brake of the braking apparatus cooperates with the guide rail as the stationary component to brake the elevator car.

32. A method for measuring a load acting on an elevator car, the method comprising the steps of:
fixing the braking apparatus according to claim 16 to the elevator car;
activating the brake of the braking apparatus to hold the elevator car relative to a stationary component while the elevator car is stationary; and
measuring a load acting on the elevator car by the load measuring device of the braking apparatus.
